(19) United States
(12) Patent Application Publication
(10) Pub. No.: US 2006/0050517 A1
(43) Pub. Date: Mar. 9, 2006

(54) Lamps and lampshades for selectively depicting visual elements

(76) Inventors: Anita B. LaFleiche, Powell, WY (US); Gnut P. Gjovik, Powell, WY (US); Kimela S. Asay, Powell, WY (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/221,366

(22) Filed: Sep. 7, 2005

Related U.S. Application Data
(60) Provisional application No. 60/607,650, filed on Sep. 7, 2004.

(51) Int. Cl. F21V 11/00

(52) U.S. Cl. 362/351; 40/554; 40/716

(57) ABSTRACT

Lamps, lampshades and methods for manufacturing lampshades providing an individual the ability to individually select specific visual pictures or symbols to be included and displayed when a light source is turned on. When a user turns on the lamp assembly, the selected visual pictures or symbols are prominently displayed such that the lamp assembly simultaneously acts as an area lighting source and a visually appealing display. The lampshade can include a single visual picture or symbol or can comprise multiple visual elements. Selected visual elements can be present either in black-and-white or color to produce a desired appearance in combination with the lampshade material and the light source within the lamp assembly.

### PRIORITY CLAIM

The present application claims priority to U.S. Provisional Patent Application No. 60/607,650 filed Sep. 7, 2004, and entitled, “LAMPS AND LAMPSHADES FOR SELECTIVELY DEPICTING VISUAL ELEMENTS,” which is herein incorporated by reference in its entirety.

### FIELD OF THE INVENTION

The present invention relates generally to lamps and lampshades. More particularly, the present invention relates to lamps, lampshades and methods for manufacturing lampshades so as to display selected visual images when a lamp assembly is turned on.

### BACKGROUND OF THE INVENTION

Lamps and their corresponding lampshades are well known and widely used in a variety of settings. For example, lamps can be used to provide all of the lighting requirements in a specified area, to supplement overhead lighting or as a decorative element within a room. Lamps are available in a wide variety of configurations including floor lamps, desk lamps and many alterative configurations. A typical lamp assembly includes a base member, an electrical assembly including a switch and bulb assembly and a lampshade.

Lampshades generally comprise a large percentage of the overall visual appearance of a lamp assembly. As such, lamps and lampshades are often specifically selected for use due to their overall visual appearance as opposed to operation characteristics. As such, lampshades are available in a wide variety of different styles that can make use of differing materials of construction as well as differing shapes and sizes. In addition, lampshades can be selected that have desired colors and patterns. In some instances, lampshades can be selected that include hand-painted scenes or pictures. As is typical with custom components, specifically tailoring custom lampshades can be both expensive and time consuming as lampshades are generally mass-produced, which tends to be non-conducive to the production of custom lampshades.

### SUMMARY OF THE INVENTION

Lampshades and methods of manufacturing lampshades of the present disclosure provide for the production of custom lampshades specifically tailored to display a visual feature desired and individually selected by a purchaser. Using the methods disclosed herein, small quantities of custom lampshades can be manufactured quickly and inexpensively.

A custom lampshade of the present invention allows a purchaser to select specific visual pictures or symbols to be included as part of the lampshade. When a user turns on the lamp assembly, the selected visual pictures or symbols are prominently displayed such that the lamp assembly simultaneously acts as a light source and a visually appealing display. The lampshade of the present invention can include a single visual picture or symbol or can comprise multiple visual elements. The visual elements can be present either in black and white or color to produce a desired appearance in combination with the lampshade material and the light emitted from the lamp assembly.

In one aspect, a lampshade of the present invention comprises a lampshade having at least one selected visual element incorporated into the shade material such that visual element is displayed when a lamp assembly is turned on.

In another aspect, the present invention comprises a method of fabricating lampshades such that at least one selected visual element is displayed when a lamp assembly is turned on.

In still another aspect, the present invention comprises a lamp assembly having a lampshade that displays a user-selected visual element when the lamp assembly is turned on.

Other advantages of the present invention will become apparent from the following detailed description and accompanying drawings.

### BRIEF DESCRIPTION OF THE DRAWINGS

The invention can be more completely understood and appreciated by referring to the following more detailed description of the presently preferred exemplary embodiments of the invention in conjunction with the accompanying drawings, of which:

FIG. 1 is a partially cut-away side view of a lamp assembly.

FIG. 2 is a top view of a plurality of visual elements.

FIG. 3 is a top view of a visual element prior to scanning by a digital scanner.

FIG. 4 is a front view of a computer monitor with a digital print of the visual element.

FIG. 5 is a front view of a computer monitor depicting a print layout of a plurality of digital prints corresponding to the visual elements of FIG. 2.

FIG. 6 is a top view of a printer printing the print layout shown in FIG. 5 onto a lampshade material.

FIG. 7 is a top view of the lampshade material of FIG. 6 including the visual elements of FIG. 2.

FIG. 8 is a perspective view of the lampshade material being cut to size.

FIG. 9 is a perspective view of the cut lampshade material being marked for a hole punch.

FIG. 10 is a top view of the cut lampshade material being hole punched.

FIG. 11 is a perspective view of a top ring being wrapped with gum tape.

FIG. 12 is an end view of the cut lampshade material formed into the shape of a lampshade.

FIG. 13 is an end view of an assembled lampshade.

FIG. 14 is a side view of the assembled lampshade of FIG. 13.

FIG. 14 is a side view of the assembled lampshade of FIG. 13 as part of a lamp assembly that has been turned on.

### DETAILED DESCRIPTION OF THE PREFERRED EMBODIMENTS

In the following detailed description of the present invention, numerous specific details are set forth in order to provide a thorough understanding of the present invention. However, it will be obvious to one skilled in the art that the present invention may be practiced without these specific details. In other instances, well-known methods, procedures, and components have not been described in detail so as to not unnecessarily obscure aspects of the present invention.

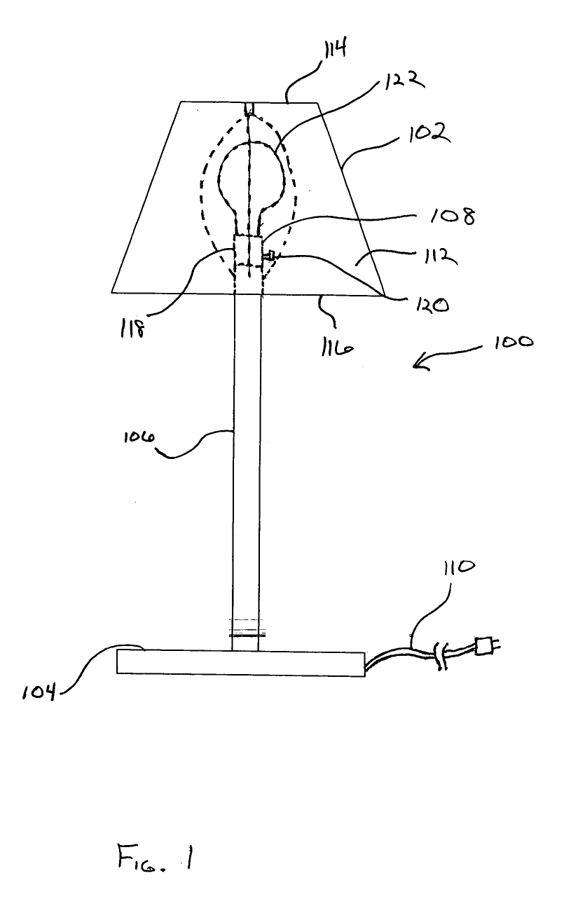

A lamp assembly 100 is illustrated in FIG. 1. Generally, lamp assembly 100 comprises a lampshade 102 and a lamp base 104. Lamp base 104 can comprise a lamp column 106, a light source assembly 108 and a cord assembly 110. Lampshade 102 is generally defined by a shade material 112, a top ring 114 and a bottom ring 116. Shade material 112 can be wrapped about and attached to the top ring 114 and bottom ring 116 by suitable means such as by enclosing the rings within a sewn pocket or by wrapping a string through holes in the shade material 112 and around the rings. Shade material 112 can comprise any suitable translucent or semi-translucent lampshade material having a Dulkote backing. Lamp column 106 includes a support assembly 114 for supporting the lampshade 102. Lamp column 106 can have any suitable height such that lamp assembly 100 can function as a floor lamp or table lamp. Lamp column 106 can be comprised of suitable materials such as wood, plastic or metals such as steel, brass, bronze and the like. In alternative embodiments, lamp column 106 may include decorative features and designs or may be shaped so as to allow attachment of lamp assembly 100 directly to a wall or ceiling. Light source assembly 108 can comprises a receptacle 118, a switch 120 and a light bulb 122. Light bulb 122 can comprise a standard filament-type light bulb as well as an energy-efficient halogen type light bulb. Light source assembly 108 is operatively connected to cord assembly 110 such that the manipulation of switch 120 allows light bulb 122 to be turned on and off.

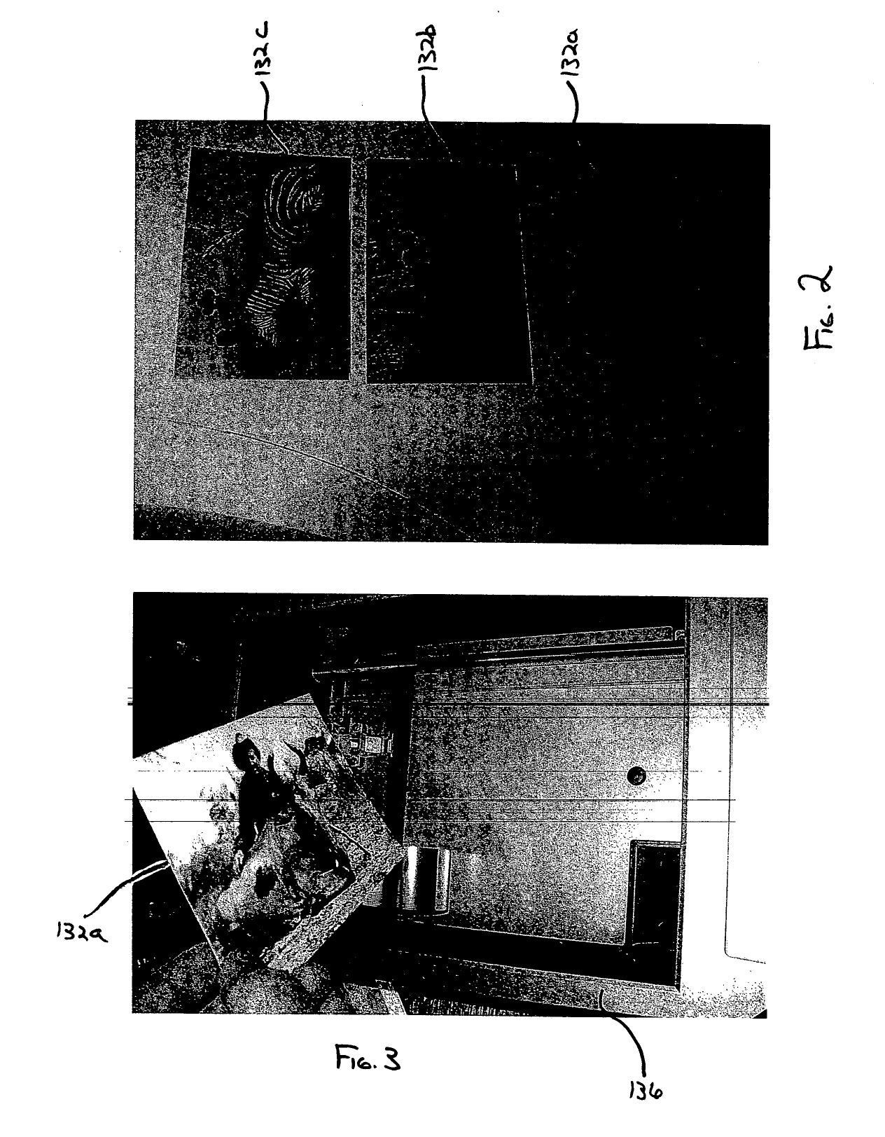

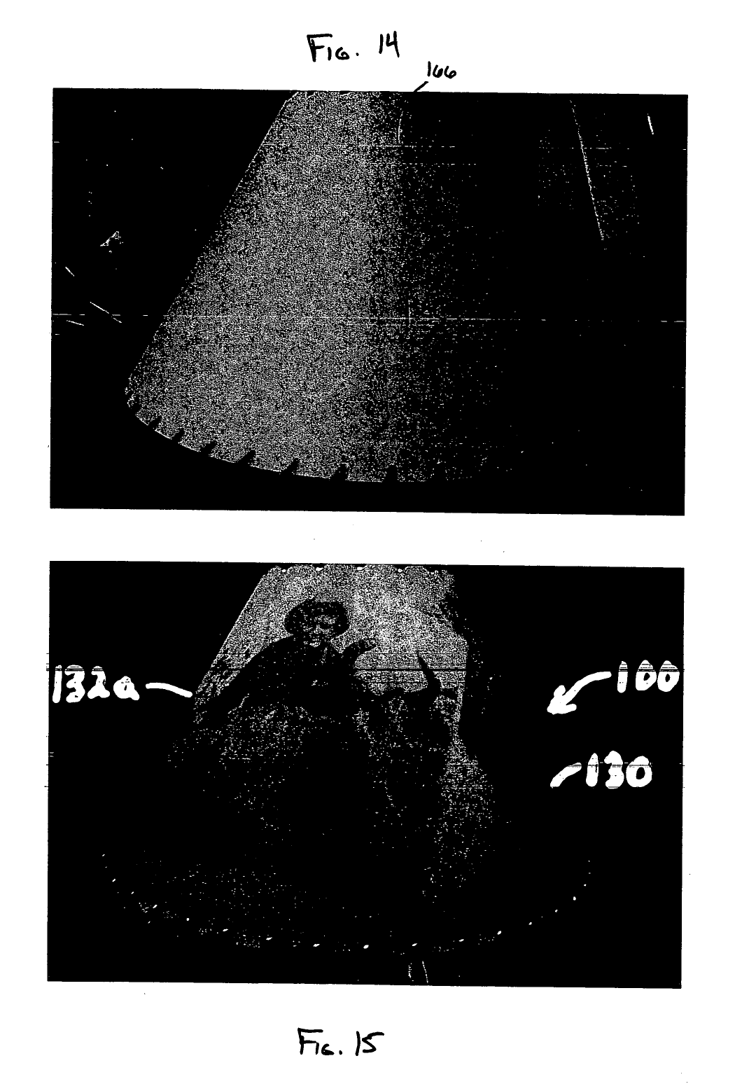

A custom lampshade 130 of the present invention is illustrated in FIGS. 13, 14 and 15. The process for fabricating and assembling custom lampshade 130 is illustrated in FIGS. 2-12. As shown in FIG. 2, a first fabrication step involves the selection of a desired visual element for display by the custom lampshade 130. The selection can comprise a single visual element or a plurality of visual elements 132a, 132b and 132c as illustrated in FIG. 2. Visual elements 132a, 132b and 132c are in the form of photographs, though other visual depictions such as artwork, documents, logos or the like can be used as well. Typically, the selected visual elements will have special sentimental meaning to an individual such as, for example, photographs of hunting trophies as illustrated in FIGS. 2-10, 12, 13 and 15. Other representative visual elements can comprise family pictures, vacation pictures, bible verses, company logos and the like.

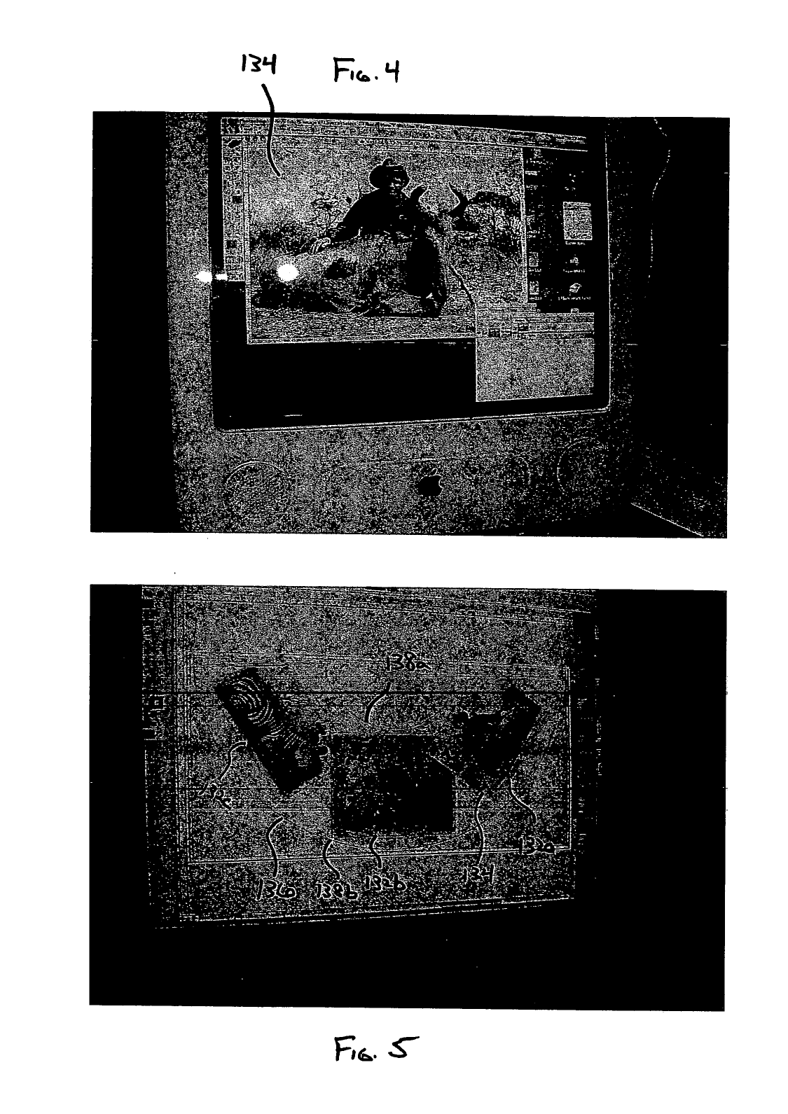

Once the visual element has been selected, the visual element, for example visual element 132a, is converted to a digital image 134 using a scanner 136, as shown in FIGS. 3 and 4. Alternatively, the visual element may already exist as a digital image such as, for example, when the visual image comprises a picture taken by a digital camera or the visual element was digitally created using suitable image software and a computer processor, such that no scanning is necessary.

Visual elements 132a, 132b and 132c can then be imported into a software program for positioning and layout, as shown in FIG. 5. Visual elements 132a, 132b and 132c are positioned on a lampshade template 136. Lampshade template 136 is a specifically dimensioned template corresponding to the desired dimensions of custom lampshade 130. Lampshade template 136 includes a top arc 138a and a bottom arc 138b wherein the length of top arc 138a corresponds to a top ring circumference 140 and the length of bottom arc 138b corresponds to a bottom ring circumference 142, as shown in FIG. 13.

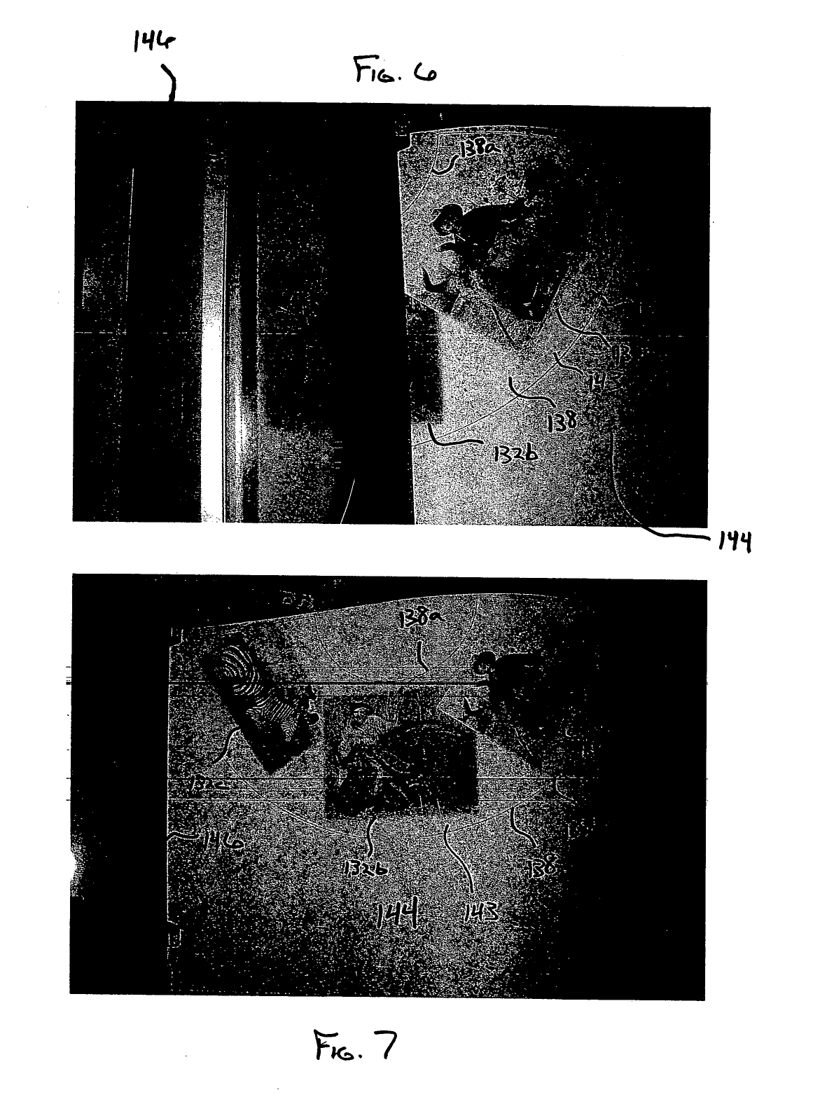

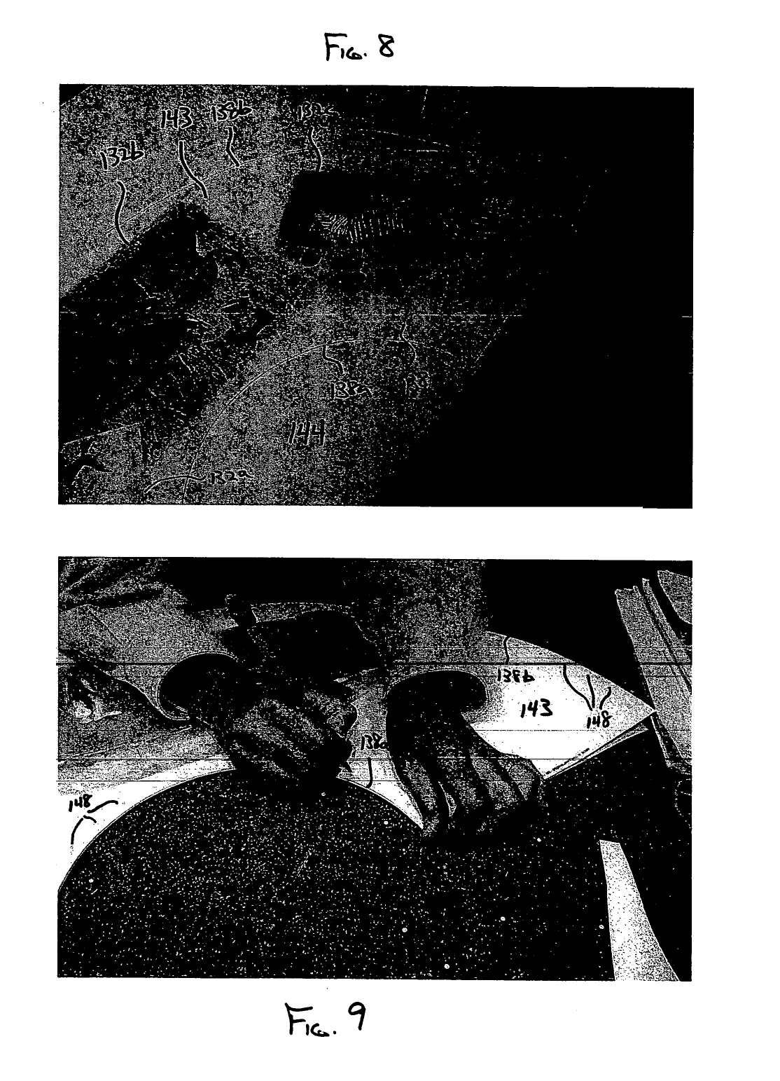

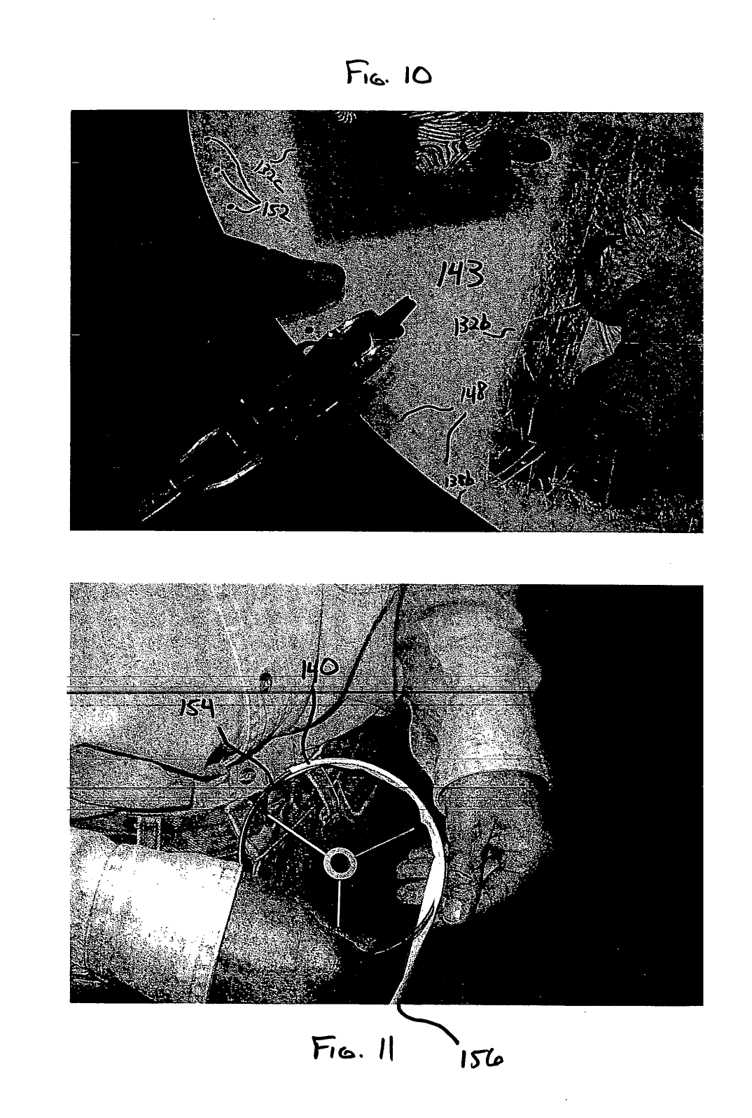

Once the visual elements 132a, 132b and 132c are positioned on template 138, a custom template 143 (consisting of template 138 and visual elements 132a, 132b and 132c) is printed on a lampshade material 144 using a color printer 146, as shown in FIGS. 6 and 7. Lampshade material 144 must comprise a material suitable for the prevention of smearing or streaking of the ink. For example, the use of a typical hard-backed vinyl coated paper will not prevent visual elements 132a, 132b and 132c from being rubbed off. An example of a suitable lampshade material 144 is a dual-coat backed paper. In one representative embodiment, printer 146 uses an archival quality colored ink to provide visual elements 132a, 132b and 132c with increased light fastness. An example of a representative archival ink includes UltraChrome™ ink available from Epson®. Following printing, custom template 143 is cut-out with a knife or scissors, as illustrate in FIG. 8, and a plurality of punch marks 148 are placed along the top arc 138a and the bottom arc 138b, as shown in FIG. 9. Finally, a hole punch 150 is used to punch a plurality of fastening holes 152 at each of the punch marks 148, as shown in FIG. 10.

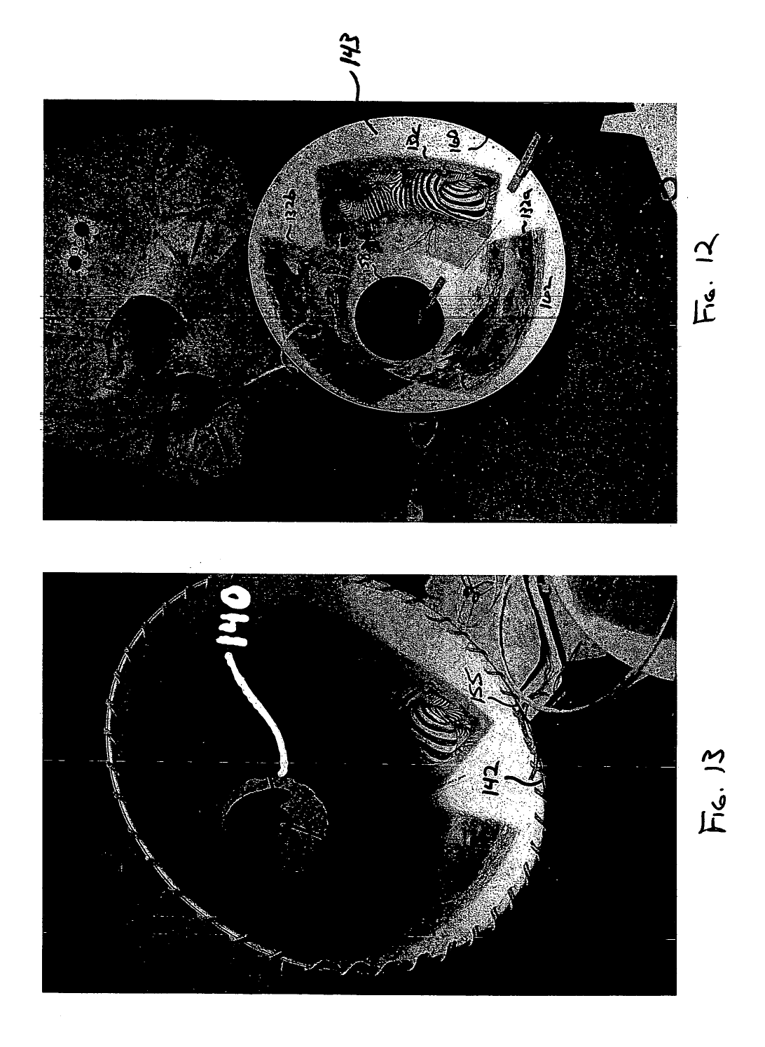

Once custom template 143 has been cut and punched, a top ring 154 is wrapped with gum tape 156 as shown in FIG. 11. Top ring 154 has top ring circumference 140. A bottom ring 155 having a bottom ring circumference 142 is similarly wrapped. Custom template 143 is then rolled to form a cylindrical shape, as shown in FIG. 12, such that the top arc 138a defines a top opening 158 and the bottom arc 138b forms a bottom opening 160. Custom template 143 is rolled such that visual elements 132a, 132b and 132c are on an inside shade surface 162. The top ring 154 is placed into top opening 158 while the bottom ring is placed into bottom opening 160 such that a banding element 164 can be continually wrapped and tied through the fastening holes 152 and around the rings, either top ring 154 or the bottom ring 155, as shown in FIG. 13. Upon completion of the wrapping and tying of banding element 164, custom lampshade 130 is complete, as shown in FIG. 14. Using an unassisted eye, visual elements 132a, 132b and 132c are not visible on an exterior shade surface 166 when viewing custom lampshade 130 from a side orientation as illustrated in FIG. 14.

In use, custom lampshade 130 is used as part of a lamp assembly, for example lamp assembly 100. When switch 120 is in an off position, visual elements 132a, 132b and 132c cannot be seen when looking at the lamp assembly 100 from the side. When switch 120 is turned on, light emitted from light bulb 122 causes the visual elements 132a, 132b and 132c to be visible when viewing the lamp assembly 100 from the side. In a preferred embodiment, light bulb 122 will be of a sufficient wattage to provide easy viewing of the visual elements 132a, 132b and 132c. If visual elements 132a, 132b and 132c are printed using colored inks, the individual colors can be viewed when light bulb 122 is in the on position.

Although various embodiments of the invention have been disclosed here for purposes of illustration, it should be understood that a variety of changes, modifications and substitutions may be incorporated without departing from either the spirit or scope of the present invention.

What is claimed:

1. A visually appealing lampshade comprising:
a lampshade having a shade material wrapped around a top ring and a bottom ring so as to define a top opening and a bottom opening, the lampshade having an exterior shade surface and an interior shade surface; and
a selected visual image residing on the interior shade surface wherein the presence of a light source within the lampshade allows an unassisted eye to see the selected visual image through the exterior shade surface.

2. The visually appealing lampshade of claim 1, wherein the interior shade surface comprises a dulkote backing.

3. The visually appealing lampshade of claim 1, wherein the selected visual image comprises a printed image formed from an archival quality ink.

4. The visually appealing lampshade of claim 3, wherein the printed image is printed from a digital image wherein the digital image is selected from the group comprising: a digital photograph, a digitally scanned picture and a computer-generated digital image.

5. The visually appealing lampshade of claim 1, wherein the selected visual image is selected from the group comprising: a photograph, a drawing, a painting, a document and a logo.

6. The visually appealing lampshade of claim 5, wherein the selected visual image comprises a color image or a black-and-white image.

7. The visually appealing lampshade of claim 1, wherein the shade material is attached to the top ring and the bottom ring with a banding material.

8. The visually appealing lampshade of claim 1, wherein the shade material comprises a translucent material or a semi-translucent material.

9. A lamp assembly comprising:
a lamp base having a light bulb and a light switch, and
a lampshade having an exterior shade surface and an interior shade surface wherein at least one selected visual element is present on the interior shade surface,
wherein the lamp shade is operably mounted to the lamp base such that the light bulb resides within an interior portion of the lampshade; and
wherein the light bulb causes the at least one selected visual element to be seen with an unassisted eye though the exterior shade surface when the light switch is placed in an on-position.

10. A method for forming a custom lampshade comprising:
selecting a visual image for display;
placing the visual image on a lampshade material; and
forming a generally cylindrical lampshade from the lampshade material such that the visual image resides on an interior shade surface.

11. The method of claim 10, wherein the steps of selecting and placing the visual image are repeated so as to select and place a plurality of visual images.

12. The method of claim 10, wherein placing the visual image on the lampshade material comprises printing the visual image on the lampshade material.

13. The method of claim 12, wherein the visual image comprises a digitally formatted image selected from the group comprising: a digital photograph, a digitally scanned picture and a computer generated digital image.

14. The method of claim 12, further comprising the step of:
attaching the generally cylindrical lampshade to a lamp base such that a light source resides within the generally cylindrical lampshade.

15. The method of claim 15, further comprising the step of:
initiating the light source such that the visual image is viewed through an exterior shade surface by an unassisted eye.

16. The method of claim 10, wherein the visual image is selected from the group comprising:
a photograph, a drawing, a painting, a document and a logo.

17. The method of claim 10, wherein the visual image comprises a color image or a black-and-white image.
